(19) United States
(12) Patent Application Publication
(10) Pub. No.: US 2021/0334917 A1
(43) Pub. Date: Oct. 28, 2021

(54) METHOD FOR PROVIDING REAL ESTATE SERVICE USING AUTONOMOUS VEHICLE

(71) Applicant: LG Electronics Inc., Seoul (KR)

(72) Inventors: Yong Soo PARK, Seoul (KR); Hyong Guk KIM, Seoul (KR); Hyeong Jin IM, Seoul (KR); Jaehoon CHO, Seoul (KR); Hee Jeong HEO, Seoul (KR); Yoonjung HONG, Seoul (KR)

(21) Appl. No.: 16/490,507

(22) PCT Filed: Feb. 14, 2019
(86) PCT No.: PCT/KR2019/001854

§ 371 Date: Aug. 30, 2019

(51) Int. Cl. G06Q 50/16; G07C 9/00

(52) U.S. Cl. CPC G06Q 50/16; G07C 9/00309

(57) ABSTRACT

A method of providing real estate services using an autonomous vehicle including receiving desired-real-estate information through a human machine interface (HMI) provided in an autonomous vehicle, extracting a plurality of pieces of real-estate-for-sale information corresponding to the desired-real-estate information from a database, and transmitting the plurality of pieces of extracted real-estate-for-sale information to the HMI, receiving desired-real-estate-for-sale information selected by a user through the HMI, generating a path for autonomous driving to desired real estate for sale on the basis of the location of the desired real estate for sale and visit information on the desired real estate for sale included in the desired-real-estate-for-sale information, and when the location of the autonomous vehicle and the location of the desired real estate for sale are within a certain distance on the path for autonomous driving, assigning authority to access the desired real estate for sale to the user.

### TECHNICAL FIELD

The present disclosure relates to a method for providing brokerage services for real estate transactions to a buyer and a seller of real estate using an autonomous vehicle.

### BACKGROUND

In recent years, technologies for autonomous vehicles that can autonomously travel to a destination without a driver's operation have been developed.

As autonomous vehicles have been developed, a space inside a vehicle may function as a single independent space for life and activities as well as a space for movement.

Accordingly, passengers can perform various activities while autonomous vehicles are moving. Thus, proving various services to the passengers may be hailed as one of the industries of the future.

In terms of real estate services provided for transactions, unlike other goods, objects subject to transactions are far away from clients. Additionally, the clients themselves have to check the objects subject to transactions.

In this case, transportation means that can move clients to the objects subject to transactions are required. Accordingly, attempts to use an autonomous vehicle as a transportation means have been made.

### DISCLOSURE cl Technical Problems

The objective of the present disclosure is to provide a method for offering real estate services to arrange real estate transactions through an autonomous vehicle.

Another objective of the present disclosure is to provide a method for offering real estate services, by which a path for autonomous driving is generated on the basis of visit information on real estate for sale.

Another objective of the present disclosure is to provide a method for offering real estate services, by which images of a destination, additionally selected by a user, are acquired through an autonomous vehicle after the user alights. Yet another objective of the present disclosure is to provide a method for offering real estate services, by which when real estate for sale subject to purchase is determined, an autonomous vehicle travels to the location of a seller.

Objectives of the present disclosure are not limited to what has been described. Additionally, other objectives and advantages that have not been mentioned may be clearly understood from the following description and may be more clearly understood from embodiments. Further, it will be understood that the objectives and advantages of the present disclosure may be realized via means and a combination thereof that are described in the appended claims.

### Technical Solutions

The present disclosure includes receiving desired-real-estate information through a human machine interface (HMI) provided in an autonomous vehicle, extracting a plurality of pieces of real-estate-for-sale information corresponding to the desired-real-estate information from a database, transmitting the extracted plurality of pieces of real-estate-for-sale information to the HMI, receiving desired-real-estate-for-sale information selected by a user among the plurality of pieces of real-estate-for-sale information through the HMI, generating a path for autonomous driving to desired real estate for sale on the basis of the location of the desired real estate for sale and visit information on the desired real estate for sale included in the desired-real-estate-for-sale information, and when the location of the autonomous vehicle and the location of the desired real estate for sale are within a certain distance on the path for autonomous driving, assigning authority to access the desired real estate for sale to the user, thereby arranging real estate transactions through the autonomous vehicle.

Additionally, the present disclosure may include extracting visitable real estate for sale on the basis of the visit information on a plurality of pieces of desired real estate for sale that are included in the desired-real-estate-for-sale information, and generating a path for autonomous driving to the visitable real estate for sale on the basis of the location of the extracted visitable real estate for sale, thereby generating a path for autonomous driving on the basis of visit information on real estate for sale.

Further, the present disclosure further includes receiving additional destination information through the HMI, receiving a user alighting signal through the HMI, generating a path for autonomous driving, which runs from the location of the autonomous vehicle to a location corresponding to the additional destination information back and forth, and when the location of the autonomous vehicle and the location corresponding to the additional destination information are within a certain distance, transmitting a recording initiation signal for external images to a camera provided in the autonomous vehicle, thereby acquiring images of destinations additionally selected by the user through the autonomous vehicle after the user alights.

Furthermore, the present disclosure further includes receiving a purchase decision signal for the desired real estate for sale through the HMI, acquiring the location of a seller terminal concerning the desired real estate for sale, and generating a path for autonomous driving from the location of the desired real estate for sale to the location of the seller terminal, thereby allowing the autonomous vehicle to travel to the seller when real estate for sale subject to purchase is determined.

### Advantageous Effects

The present disclosure may enhance efficiency and convenience of real estate transactions requiring movement of clients, by arranging transactions through an autonomous vehicle.

Additionally, the present disclosure may arrange transactions only for the real estate for sale that can be visited by a client, by generating a path for autonomous driving on the basis of visit information on real estate for sale, thereby preventing the client from making vain efforts to visit the real estate for sale.

Further, the present disclosure may allow a client to check facilities around real estate for sale without causing movement of the client, by acquiring images of destinations, additionally selected by the client, through an autonomous vehicle, after the client alights.

Furthermore, the present disclosure may reduce the inconvenience of contacting a seller for real estate transactions, finding out the location of the seller, and directly traveling to the location of the seller, by allowing an autonomous vehicle to travel to the location of the seller when real estate for sale subject purchase is determined.

Specific effects of the present disclosure together with the above-described effects are described in the detailed description of embodiments.

### DESCRIPTION OF THE DRAWINGS

FIG. 1 is a view illustrating a real-estate-service providing system according to an embodiment.

FIG. 2 is a view illustrating the autonomous vehicle in FIG. 1.

FIG. 3 is a view for explaining a flow of control by an HMI in an autonomous vehicle and a server.

FIG. 4 is a flow chart illustrating a method for providing real estate services according to an embodiment.

FIG. 5 is a flow chart illustrating an example of a process of generating a path for autonomous driving.

FIG. 6 is a flow chart illustrating an example of a process of driving an autonomous vehicle to an additional destination when a user alights from the vehicle.

FIG. 7 is a flow chart illustrating an example of a process of driving an autonomous vehicle to the location of a seller when a buyer makes a purchase decision.

FIG. 8 is a view illustrating operations of a server, an autonomous vehicle and a seller terminal for providing real estate services in a time series manner.

### BEST MODE

The above-described objectives, features and advantages are specifically described with reference to the attached drawings hereunder such that one having ordinary skill in the art to which the present disclosure pertains may easily implement the technical spirit of the disclosure. In describing the disclosure, detailed description of publicly known technologies in relation to the disclosure is omitted if it is deemed to make the gist of the present disclosure unnecessarily vague. Below, preferred embodiments of the present disclosure are specifically described with reference to the attached drawings. Throughout the drawings, identical reference numerals denote identical or similar elements.

The present disclosure relates to a method for providing brokerage services for real estate transactions to a buyer and a seller of real estate using an autonomous vehicle.

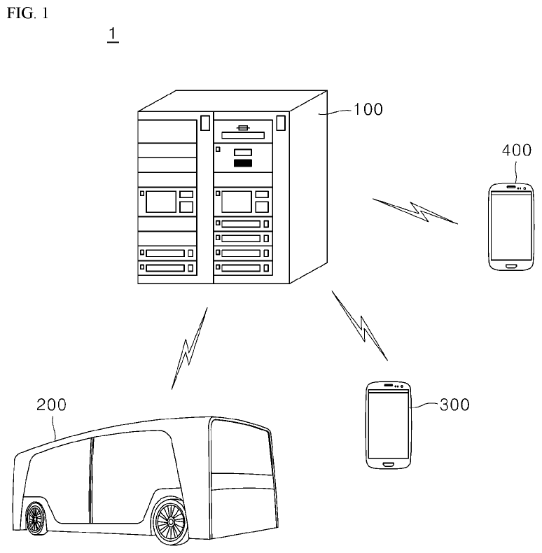

Below, a real-estate-service providing system according to an embodiment, and a method for providing real estate services by the system using an autonomous vehicle are described with reference to FIGS. 1 to 8.

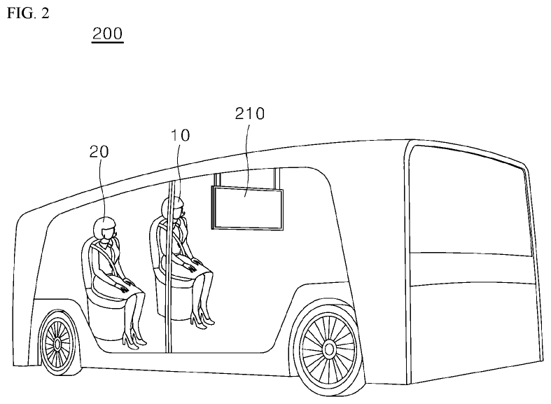

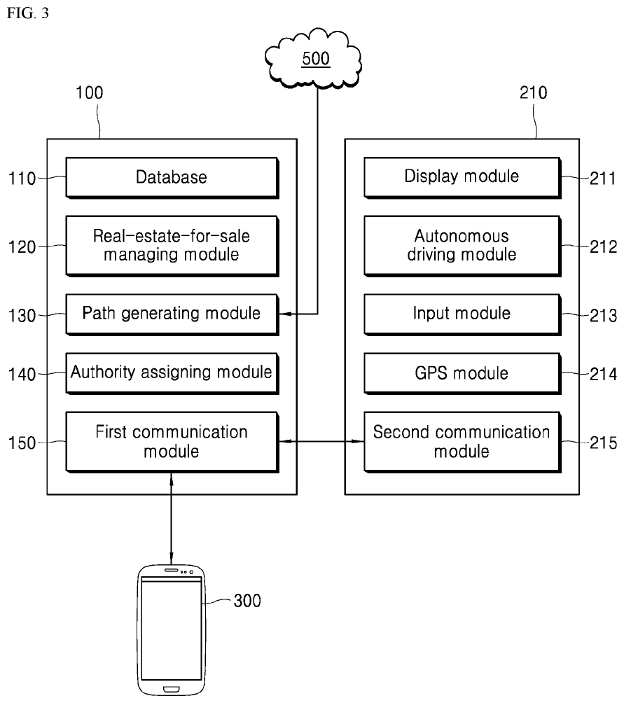

FIG. 1 is a view illustrating a real-estate-service providing system according to an embodiment, FIG. 2 is a view illustrating the autonomous vehicle in FIG. 1, and FIG. 3 is a view for explaining a flow of control by an HMI in an autonomous vehicle and a server.

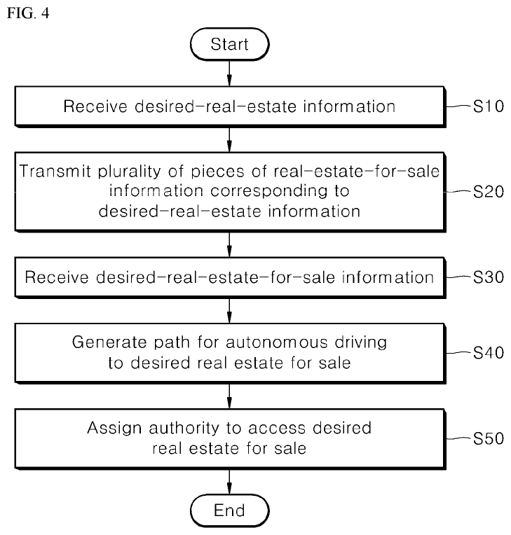

FIG. 4 is a flow chart illustrating a method for providing real estate services according to an embodiment.

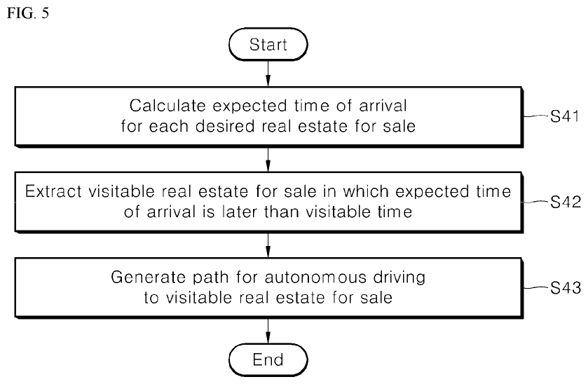

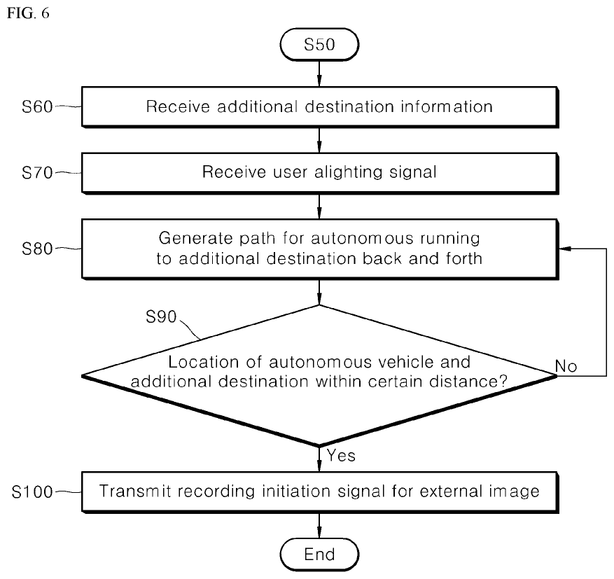

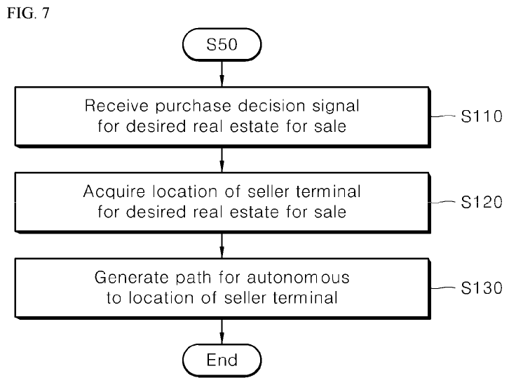

FIG. 5 is a flow chart illustrating an example of a process of generating a path for autonomous driving, FIG. 6 is a flow chart illustrating an example of a process of driving an autonomous vehicle to an additional destination when a user alights from the vehicle, and FIG. 7 is a flow chart illustrating an example of a process of driving an autonomous vehicle to the location of a seller when a buyer makes a purchase decision.

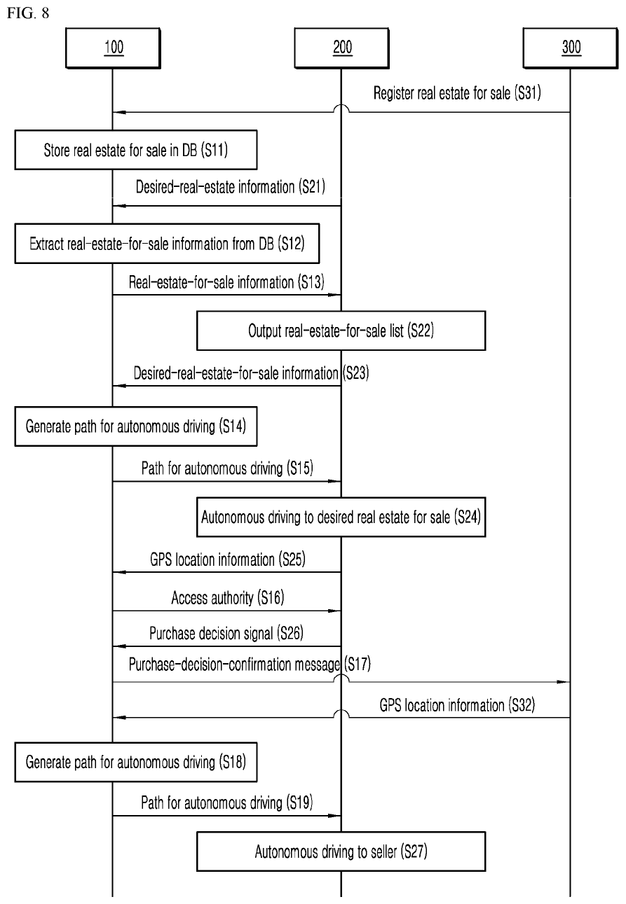

FIG. 8 is a view illustrating operations of a server, an autonomous vehicle and a seller terminal for providing real estate services in a time series manner.

In the present disclosure, real estate services may include real estate brokerage services. Accordingly, the real estate services may include services provided to a seller of real estate to sell the rear estate, and services provided to a buyer of the real estate to buy the real estate.

Referring to FIG. 1, a real-estate-service providing system 1 according to an embodiment may include a server 100, an autonomous vehicle 200, a seller terminal 300, and a user terminal 400. The real-estate-service providing system 1 illustrated in FIG. 1 is based on an embodiment, and elements thereof are not limited to the embodiment illustrated in FIG. When necessary, some elements may be added, modified or removed.

The server 100, the autonomous vehicle 200, the seller terminal 300, and the user terminal 400, which constitute the real-estate-service providing system 1, may connect to a wireless network and may perform data communication with one another. In the present disclosure, the seller terminal 300 may be defined as a terminal of a seller of real estate for sale, and the user terminal 400 may be defined as a terminal of a broker or a buyer of the real estate for sale.

The autonomous vehicle 200 denotes a vehicle that drives itself to a destination without a driver's operation. The autonomous vehicle 200 may include any transportation means such as automobiles, motorcycles and the like, but below, denotes automobiles for convenience of description.

A real estate broker company may manage the autonomous vehicle 200, and a real estate agent and a buyer may get into the autonomous vehicle 200 during a below-described process in which real estate services are provided.

Referring to FIG. 2, the autonomous vehicle 200 may be provided with a Human Machine Interface (HMI) 210 therein. Basically, the HMI 210 may perform the function that outputs information on a vehicle or on the state of a vehicle to a driver through a plurality of physical interfaces visually and acoustically. Additionally, in a below-described process of providing real estate services, the HMI 210 may receive an input of user manipulation or may output information on real estate to provide real estate services. Further, the HMI 210 may perform the function that controls autonomous driving of the autonomous vehicle 200.

The server 100 may be built on the basis of a cloud and may store and manage information collected from the autonomous vehicle 200, the seller terminal 300 and the user terminal 400 that connect to a wireless network. The server 100 may be managed by a real estate broker company, and may control the autonomous vehicle 200 using wireless data communication.

Referring to FIG. 3, the server 100 according to an embodiment may include a database 110, a real-estate-for-sale managing module 120, a path generating module 130, an authority assigning module 140, and a first communication module 150. The HMI 210, provided in the autonomous vehicle 200 according to an embodiment of the present disclosure, may include a display module 211, an autonomous driving module 212, an input module 213, a GPS module 214, and a second communication module 215.

The server 100 and HMI 210 illustrated in FIG. 3 are based on an embodiment, and elements thereof are not limited to the embodiment illustrated in FIG. 3. When necessary, some elements may be added, modified or removed.

Each of the modules that constitute the server 100, and the HMI 210 of the autonomous vehicle 200 may be implemented as at least one physical element among application specific integrated circuits (ASICs), digital signal processors (DSPs), digital signal processing devices (DSPDs), programmable logic devices (PLDs), field programmable gate arrays (FPGAs), processors, controllers, micro-controllers, and microprocessors.

Referring to FIG. 4, a method for providing real estate services using an autonomous vehicle 200 according to an embodiment (hereinafter referred to as a method for providing real estate services) may include receiving desired-real-estate information (S10), transmitting a plurality of pieces of real-estate-for-sale information corresponding to the desired-real-estate information (S20), receiving desired-real-estate-for-sale information (S30), generating a path for autonomous driving to desired real estate for sale (S40), and assigning authority to access the desired real estate for sale (S50).

The steps in the method for providing real estate services may be performed by the server 100. The server 100 may perform data communication with the autonomous vehicle 200, the seller terminal 300, and the user terminal 400 to perform the operation in each of the steps illustrated in FIG. 4.

Below, each of the steps illustrated in FIGS. 4 to 7 is specifically described.

A server 100 may receive desired-real-estate information through an HMI 210 provided in an autonomous vehicle 200 (S10).

Specifically, a first communication module 150 provided in the server 100 and a second communication module 215 provided in the HMI 210 may perform wireless data communication, and a real-estate-for-sale managing module 120 of the server 100 may receive desired-real-estate information from the HMI 210 through the first communication module 150.

The desired-real-estate information is information on real estate desired by a buyer and may be selected by the buyer.

The buyer aboard the autonomous vehicle 200 may input the desired-real-estate information through an interface displayed on a display module 211 of the HMI 210. User manipulation for inputting the desired-real-estate information may be performed in various ways, and for example, may be performed by a touch of the buyer on the display module 211.

An input module 213 of the HMI 210 may dataize the desired-real-estate information by receiving an input of user manipulation. As an example, if manipulation of a user is a touch of a buyer, the input module 213 may identify desired-real-estate information corresponding to the position of the touch that occurs in the interface displayed on the display module 211. As another example, if manipulation of a user is the voice of a buyer, the input module 213 may recognize the voice of the buyer and identify desired-real-estate information corresponding to the recognized voice.

The input module 213 may dataize the identified desired-real-estate information and may transmit the dataize desired-real-estate information to the server 100 through the second communication module 215, and the server 100 may receive the desired-real-estate information by the operation of the HMI 210 that is described above.

The sever 100 may receive desired-real-estate information including at least one among pieces of information such as an area in which the desired real estate is located, a price of the desired real estate, and the type of the desired real estate through the HMI 210. That is, desired-real-estate information may include at least one among pieces of information such as the area in which desired real estate is located, the price of desired real estate, and the type of desired real estate.

The area may be determined by any boundary on a map, an address and the like, the price may be set to a specific value or to a certain range. Additionally, the type may be determined on the basis of the purpose of use of real estate, the structure of real estate and the like. For example, real estate may be classified as an apartment, a flat, an officetel, a commercial building and the like.

Further, the desired-real-estate information, as any information on desired real estate, may include various pieces of information such as information on whether the desired real estate has a garden, whether the desired real estate has a parking space, the floor and story of the desired real estate, a distance between the desired real estate and an adjacent real estate agency, and the like.

The server 100 may extract a plurality of pieces of real-estate-for-sale information corresponding to the desired-real-estate information from the database 110, and may transmit the extracted plurality of pieces of real-estate-for-sale information to the HMI 210 (S20).

Specifically, the real-estate-for-sale managing module 120 provided in the server 100 may extract a plurality of pieces of real-estate-for-sale information corresponding to the desired-real-estate information received from the HMI 210, from the database 110.

Real-estate-for-sale information collected from a seller of real estate may be previously stored in the database 110 inside the server 100. The real-estate-for-sale information may be transmitted by a seller terminal 300 of a seller of real estate and may be received through the first communication module 150. Additionally, the real-estate-for-sale managing module 120 may accumulate and store the real-estate-for-sale information, received from a user terminal 400, in the database 110.

The real-estate-for-sale information, as information that corresponds to the desired-real-estate information, may include all the items included in the desired-real-estate information. For example, when the desired-real-estate information includes the location of real estate, the price of real estate, and the type of real estate, the real-estate-for-sale information may also include the location of real estate, the price of real estate, and the type of real estate.

The real-estate-for-sale managing module 120 may extract real-estate-for-sale information matched with the desired-real-estate information, among pieces of the real-estate-for-sale information stored in the database 110. For example, the real-estate-for-sale information stored in the database 110 may be shown as in [Table 1].

TABLE 1

| | [Loca- | | | | [Parking | |
|---|---|---|---|---|---|---|
| | tion] | [Price] | [Type] | [Yard] | lot] | [Floor] |
| Real estate | A-1 | 20 | Flat | X | X | 1 |
| for sale 1 | | | | | | |
| Real estate | A-2 | 30 | Officetel | X | X | 3 |
| for sale 2 | | | | | | |
| Real estate | B-1 | 35 | Apartment | X | ◯ | 9 |
| for sale 3 | | | | | | |
| Real estate | C-1 | 60 | Flat | ◯ | ◯ | 1 |
| for sale 4 | | | | | | |
| Real estate | C-2 | 40 | Flat | ◯ | X | 1 |
| for sale 5 | | | | | | |

Referring to [Table 1], real-estate-for-sale information may include items such as the location of real estate for sale, the price of real estate for sale, the type of real estate for sale, the question of whether real estate for sale has a yard, the question of whether real estate for sale has a parking lot, the floor of real estate for sale and the like.

As an example, desired-real-estate information received from the HMI 210 may include items such as the location of desired real estate, the price of desired real estate, the type of desired real estate, and the question of whether desired real estate has a parking lot, as in [Table 2].

TABLE 2

| | [Location] | [Price] | [Type] | [Parking lot] |
|---|---|---|---|---|
| Desired real | A-1 | 20~40 | Flat | X |
| estate | | | | |

In this case, the real-estate-for-sale managing module 120 may extract real-estate-for-sale information matched with desired-real-estate information, among pieces of real-estate-for-sale information stored in the database 110. That is, the real-estate-for-sale managing module 120 may extract real estate for sale 1 as real-estate-for-sale information.

The real-estate-for-sale managing module 120 may dataize the extracted real-estate-for-sale information and may transmit the dataized real-estate-for-sale information to the HMI 120 through the first communication module 150, and the display module 211 of the HMI 120 may output the received real-estate-for-sale information visually.

The real-estate-for-sale managing module 120 may generate a real-estate-for-sale list on which a plurality of pieces of real-estate-for-sale information are listed in the order of high similarity to desired-real-estate information, and may transmit the generated real-estate-for-sale list to the HMI 120.

Specifically, the real-estate-for-sale managing module 120 may extract a plurality of pieces of real-estate-for-sale information in the order in which the number of items of real-estate-for-sale information matched with items of desired-real-estate information, among pieces of real-estate-for-sale information stored in the database 110, is larger, and may generate a real-estate-for-sale list using the extracted real-estate-for-sale information.

When real-estate-for-sale information stored in the database 110 is shown as in [Table 1], and when desired-real-estate information received from the HMI 210 is shown as in [Table 2], the number of items of the real-estate-for-sale information matched with items of the desired-real-estate information is four (location, price, type, parking lot) in real estate for sale 1, two (price, parking lot) in real estate for sale 2, one (price) in real estate for sale 3, and zero in real estate for sale 4, three (price, type, parking lot) in real estate for sale 5.

In this case, the real-estate-for-sale managing module 120 may generate a real-estate-for-sale list as in [Table 3] in the order of larger numbers of items of real-estate-for-sale information, among pieces of real-estate-for-sale information, matched with items of desired-real-estate information.

TABLE 3

| | [Location] | [Price] | [Type] | [Parking lot] |
|---|---|---|---|---|
| Real estate | A-1 | 20 | Flat | X |
| for sale 1 | | | | |
| Real estate | C-2 | 40 | Flat | X |
| for sale 5 | | | | |
| Real estate | A-2 | 30 | Officetel | X |
| for sale 2 | | | | |
| Real estate | B-1 | 35 | Apartment | ◯ |
| for sale 3 | | | | |
| Real estate | C-1 | 60 | Flat | ◯ |
| for sale 4 | | | | |

The generated real-estate-for-sale list may be dataized and may be transmitted to the HMI 210 through the first communication module 150, and the display module 211 of the HMI 210 may output the received real-estate-for-sale list visually.

The real-estate-for-sale managing module 120 may identify a geo-fence on the basis of the location in which desired real estate included in desired-real-estate information is placed, and may extract a plurality of pieces of real-estate-for-sale information within the identified geo-fence.

The real-estate-for-sale managing module 120 may separate land into a plurality of areas through a virtual boundary, and may set each separated area as a geo-fence. The geo-fence, as a concept involving a location, may be separated and set based on administrative districts, or may be set as an arbitrary district based on various standards.

For example, the locations in [Table 1] that is described above may denote specific addresses, and the locations having the addresses of A-1 and A-2 may be included in geo-fence A. Additionally, the location having the address of B-1 may be included in geo-fence B, and the locations having the addresses of C-1 and C-2 may be included in geo-fence C.

When desired-real-estate information received from the HMI 210 is shown as in [Table 2], the real-estate-for-sale managing module 120 may identify geo-fence A on the basis of the area (A-1) in which desired real estate is placed, and may extract real-estate-for-sale information from two pieces of real estate for sale (real estate for sale 1 and real estate for sale 2) in the identified geo-fence A.

The methods of extracting real-estate-for-sale information from a plurality of pieces of real estate for sale, and generating a real-estate-for-sale list using the extracted real-estate-for-sale information are the same as what is described above. Accordingly, detailed description is omitted.

The server 100 may receive desired-real-estate-for-sale information selected by a user among a plurality of pieces of real-estate-for-sale information through the HMI 210 (S30).

Specifically, the real-estate-for-sale managing module 120 of the server 100 may receive desired-real-estate-for-sale information from the HMI 210 through the first communication module 150.

A buyer aboard the autonomous vehicle 200 may confirm a plurality of pieces of real-estate-for-sale information corresponding to the desired-real-estate information through the display module 211 of the HMI 210, and may select desired real estate for sale among a plurality of pieces of real estate for sale through a user manipulation.

The input module 213 of the HMI 210 may dataize the desired-real-estate-for-sale information selected on the basis of the above-described user manipulation, and may transmit the dataized desired-real-estate-for-sale information to the server 100 through the second communication module 215. The server 100 may receive the desired-real-estate-for-sale information by operations of the HMI 210.

The server 100 may generate a path for autonomous driving to desired real estate for sale on the basis of information on the location of the desired real estate for sale and visit information on the desired real estate for sale, which is included in the desired-real-estate-for-sale information (S40).

Specifically, the path generating module 130 provided in the server 100 may identify information on the location of the desired real estate for sale and visit information on the desired real estate for sale which corresponds to the desired-real-estate-for-sale information received from the HMI 210, with reference to the database 110, and may generate a path for autonomous driving to the desired real estate for sale on the basis of the identified information.

Information on the location of each piece of real estate for sale and visit information on each piece of real estate for sale may be previously stored in the database 110 inside the server 100. The information on the location of real estate for sale and visit information on real estate for sale may be transmitted by the seller terminal 300, may be received through the first communication module 150 and may be stored in the database 110.

The visit information may include information on whether real estate for sale is currently visitable, and information on visitable time when real estate for sale is visitable.

The path generating module 130 may generate a path for autonomous driving on the basis of the location of desired real estate for sale and the visit information on the desired real estate for sale. That is, the path generating module 130 may generate a path for autonomous driving to real estate for sale that is visitable, with reference to the visit information.

Specifically, the path generating module 130 may extract visitable real estate for sale on the basis of the visit information on a plurality of pieces of desired real estate for sale that are included in the desired-real-estate-for-sale information, and may generate a path for autonomous driving to the visitable real estate for sale on the basis of the location of the extracted visitable real estate for sale.

As an example, the path generating module 130 may extract real estate for sale that can be currently visited, among pieces of desired real estate for sale, on the basis of the information on whether desired real estate for sale is visitable. The path generating module 130 identifies the location of the extracted visitable real estate for sale and may generate a path for autonomous driving to the identified location.

When there is a single piece of visitable real estate for sale, the path generating module 130 may generate a path for autonomous driving from the current location of the autonomous vehicle 200 to the location of the visitable real estate for sale. When there are a plurality of pieces of visitable real estate for sale, the path generating module 130 may generate a path for autonomous driving, which passes from the current location of the autonomous vehicle 200 through all the plurality of pieces of visitable real estate for sale.

Referring to FIG. 5, the path generating module 130 may calculate expected time of arrival for each of the plurality of pieces of desired real estate for sale included in the desired-real-estate-for-sale information (S41). Next, the path generating module 130 may extract visitable real estate for sale in which expected time of arrival is later than visitable time included in the visit information, among the plurality of pieces of desired real estate for sale included in the desired-real-estate-for-sale information (S42).

Specifically, the path generating module 130 may calculate expected time of arrival of the autonomous vehicle 200 at each piece of desired real estate for sale considering information on the current location of the autonomous vehicle 200, the location of desired real estate for sale, current traffic conditions, and the like. Expected time of arrival of the autonomous vehicle 200, which is calculated by the path generating module 130, may be shown as in [Table 4].

TABLE 4

| [Desired real estate for sale] | [Expected time of arrival] |
|---|---|
| Desired real estate for sale A | 13:00 |
| Desired real estate for sale B | 15:00 |
| Desired real estate for sale C | 17:00 |
| Desired real estate for sale D | 19:00 |

For example, the visit information on desired real estate for sale may be shown as in [Table 5].

TABLE 5

| | [Whether to be | [Visitable |
|---|---|---|
| [Desired real estate for sale] | visited] | time] |
| Desired real estate for sale A | Possible | — |
| Desired real estate for sale B | Impossible | 16:00 |
| Desired real estate for sale C | Possible | — |
| Desired real estate for sale D | Impossible | 18:00 |

Accordingly, the path generating module 130 may identify desired real estate for sale A and desired real estate for sale C as desired real estate for sale that is visitable anytime, and may identify desired real estate for sale B and desired real estate for sale D as desired real estate for sale that is visitable respectively after 16:00 and 18:00.

Basically, the path generating module 130 may extract desired real estate for sale A and desired real estate for sale C that can be currently visited as visitable real estate for sale. Additionally, the path generating module 130 may extract desired real estate for sale D, in which expected time of arrival is later than visitable time, as vitable real estate for sale, among the rest pieces of desired real estate for sale B and desired real estate for sale D.

That is, the path generating module 130 may extract desired real estate for sale, which is not currently visitable but is visitable at the point in time when the autonomous vehicle 200 arrives, as visitable real estate for sale.

Next, the path generating module 130 may generate a path for autonomous driving to the visitable real estate for sale on the basis of the location of the extracted visitable real estate for sale (S43).

The path generating module 130 may generate a path for autonomous driving considering distances, time periods, traffic fares and the like. Any methods employed in the art to which the present disclosure pertains may be applied to a method for generating a path for autonomous driving by the path generating module 130. Accordingly, detailed description is omitted.

Additionally, the path generating module 130 may generate a path for autonomous driving further considering current traffic conditions. The path generating module 130, as illustrated in FIG. 3, may receive current traffic information from a traffic information sever 500 and may generate a path for autonomous driving considering the received traffic information.

Any methods employed in the art to which the present disclosure pertains may be applied to a method for reflecting the current traffic information in generating a path for autonomous driving. Accordingly, detailed description is omitted.

The present disclosure, as described above, may generate a path for autonomous driving on the basis of the visit information on real estate for sale, thereby making it possible to arrange transactions only for real estate for sale, which can be visited by a client, and to prevent the client from making vain efforts to visit the real estate for sale.

The path for autonomous driving, generated using the above-described method, may be implemented on the basis of a high definition map including three-dimensional geographical information. Accordingly, the path generating module 130 may transmit a high definition map itself, in which paths for autonomous driving are implemented, to the HMI 210, or may transmit paths for autonomous driving, which will be implemented in a high definition map, to the HMI 210.

An autonomous driving module 212 of the HMI 210 may receive a path for autonomous driving through the second communication module 215, and may control drive of the autonomous vehicle 200 on the basis of the received path for autonomous driving.

Specifically, when receiving a high definition map, the autonomous driving module 212 may control drive of the autonomous vehicle 200 on the basis of the high definition map. When receiving a path for autonomous driving, which is implemented in a high definition map, the autonomous driving module 212 may apply the path for autonomous driving to a high definition map stored in the memory of the vehicle and then may control drive of the autonomous vehicle 200 on the basis of the high definition map.

Algorithms for maintaining a distance between vehicles, preventing the autonomous vehicle 200 from escaping from the lane, tracking the lane, detecting signals, detecting a pedestrian, detecting a structure, sensing traffic conditions and the like may be applied to control exerted by the autonomous driving module 212 over the autonomous vehicle 200. In addition to the above-described algorithms, various algorithms employed in the art to which the disclosure pertains may be applied to autonomous driving.

The autonomous vehicle 200 may move along a path for autonomous driving on the basis of control by the autonomous driving module 212 without an additional user's manipulation.

The server 100 may transmit surrounding facility information on desired real estate for sale to the HMI 210 while the autonomous vehicle 200 is moving along the path for autonomous driving.

Surrounding facility information on each piece of real estate for sale may be previously stored in the database 110 inside the server 100, and the real-estate-for-sale managing module 120 may extract surrounding facility information on desired real estate for sale, headed by the autonomous vehicle 200, from the database 110, and may transmit the extracted surrounding facility information to the HMI 210.

The surrounding facility information, as information on surrounding facilities that are located within a certain distance apart from real estate for sale, may include information on a school, an oil station, a commercial building, a hospital, a large-scale retailer, a convenience store and the like.

The display module 211 provided in the HMI 210 may visually output information on the locations of surrounding facilities, the images of surrounding facilities, a moving path from desired real estate for sale to the surrounding facilities and the like, on the basis of surrounding facility information received through the second communication module 215.

By doing so, a buyer may find out various facilities around desired real estate for sale while moving to the desired real estate for sale, and may consider the surrounding facilities when making a decision to purchase the desired real estate for sale.

The server 100 may give the authority to access desired real estate for sale to a user when the location of the autonomous vehicle 200 and the location of the desired real estate for sale are within a certain distance on the path for autonomous driving (S50).

The authority assigning module 140 provided in the server 100 may identify a distance between the location of the autonomous vehicle 200 and the location of desired real estate for sale. Specifically, a global positioning system (GPS) module of the autonomous vehicle 200 may receive signals transmitted by a satellite and may calculate the current location of the autonomous vehicle 200. The GPS module 214 may transmit the calculated current location to the server 100 through the second communication module 215.

The authority assigning module 140 may compare the current location of the autonomous vehicle 200, which is received through the first communication module 150, with the location of desired real estate for sale, for which the autonomous vehicle 200 is currently destined. When a distance between the current location of the autonomous vehicle 200 and the location of the desired real estate for sale as a result of the comparison is within a preset certain distance, the authority assigning module 140 may assign the authority to access the desired real estate for sale to a user.

Specifically, the authority assigning module 140 may identify the authority to access desired real estate for sale with reference to the database 110, and may transmit the identified access authority to the HMI 210 in the autonomous vehicle 200 or to the user terminal 400.

The authority to access each piece of real estate for sale may be previously stored in the database 110 inside the server 100. The access authority may include any means to access real estate for sale.

As an example, the front door of desired real estate for sale may be provided with a digital door lock, which is a lock system without a key, and the access authority may be an access password that is used to unlock the digital door lock.

In this case, the authority assigning module 140 may transmit a password for accessing the desired real estate for sale to the HMI 210.

The display module 211 of the HMI 210 may output the access password received through the second communication module 215 visually, and accordingly, a real estate agent and a buyer of real estate may gain the authority to access the desired real estate for sale.

Additionally, the authority assigning module 140 may transmit a password for accessing desired real estate for sale to the user terminal 400.

The user terminal 400 may receive the access password from the authority assigning module 140 and may output the access password visually, and accordingly, a real estate agent or a buyer of real estate may gain the authority to access the desired real estate for sale.

Preferably, only a real estate agent may gain the authority to access desired real estate for sale before a transaction for the desired real estate for sale is completed. Accordingly, the authority assigning module 140 may transmit an access password only to a real estate agent's terminal.

As another example, the front door of desired real estate for sale may be provided with a digital door lock that is unlocked by tagging an access card. Specifically, the access card carries a virtual card key, and the digital door lock may be unlocked by indentifying the virtual card key in the access card.

In this case, the authority assigning module 140 may transmit the virtual card key of the desired real estate for sale to a user terminal in which an access application is installed, preferably, to a real estate agent's terminal.

The access application may be any software for allowing the user terminal 400 to tag the digital door lock. The virtual card key received from the authority assigning module 140 may be applied to the access application, and when the user terminal 400, in which an access application is executed, tags the digital door lock, the digital door lock may be unlocked. Through this process, a user may gain the authority to access desired real estate for sale.

Referring to FIG. 6, the server 100 may receive additional destination information through the HMI 210 while the autonomous vehicle 200 is moving to desire real estate for sale, or when the autonomous vehicle 200 arrives at desire real estate for sale (S60).

A buyer aboard the autonomous vehicle 200 may input additional destination information through user manipulation to the interface displayed on the display module 211 of the HMI 210. The additional destination information may include information on surrounding destinations around which a buyer of real estate desires to look additionally.

A method for the input module 213 of the HMI 210 dataizing the additional destination information and transmitting the dataized additional destination information to the server 100 by receiving an input of user manipulation is the same as the method for transmitting desired-real-estate information to the server 100, which is described in the step (S10) of FIG. 4. Accordingly, detailed description is omitted.

Next, the server 100 may receive a user alighting signal through the HMI 210 (S70).

Specifically, a buyer or a real estate agent aboard the autonomous vehicle 200 may input a user alighting signal before alighting from the autonomous vehicle 200 through the interface displayed on the display module 211 of the HMI 210. The input module 213 of the HMI 210 may transmit the user alighting signal to the server 100 through the second communication module 215, and the server 100 may receive the user alighting signal through the first communication module 150.

Next, the server 100 may generate a path for autonomous driving, which runs from the location of the autonomous vehicle 200 to a location corresponding to additional destination information back and forth (S80).

When a user alights from the autonomous vehicle 200, the location of the autonomous vehicle 200 may be the location of desired real estate for sale. The path generating module 130 in the server 100 may identify the location of an additional destination corresponding to the additional destination information received from the HMI 210 with reference to the database 110, and on the basis of the identified location, may generate a path for autonomous driving, which runs from the location of desired real estate for sale to the additional destination back and forth.

A method for generating a path for autonomous driving is described above. Accordingly, detailed description is omitted.

Next, the server 100 may determine whether the location of the autonomous vehicle 200 and the location corresponding to the additional destination information are within a certain distance. (S90).

Specifically, the server 100 compares the current location of the autonomous vehicle 200 received from the GPS module 214 of the autonomous vehicle 200, with the location of the additional destination, to determine whether a distance between the autonomous vehicle 200 and the additional destination is within a certain distance.

When a distance between the autonomous vehicle 200 and the additional destination exceeds a certain distance as a result of determination, the server 100 may continuously generate a path for autonomous driving and may allow the autonomous vehicle 200 to move.

When a distance between the autonomous vehicle 200 and the additional destination is within a certain distance as a result of determination, the server 100 may transmit a recording initiation signal for external images to a camera (not illustrated) provided in the autonomous vehicle 200 (S100).

Specifically, in the autonomous vehicle 200, one or more cameras capable of recording images outside the vehicle may be provided. Each of the cameras may receive a recording initiation signal from the server 100, and when receiving the recording initiation signal, may record images around the additional destination and may store the images in the memory inside the autonomous vehicle 200.

That is, when the autonomous vehicle 200 approaches to the additional destination on the path for autonomous driving, which runs from the location of desired real estate for sale to the location of the additional destination back and forth, the cameras may record images around the additional destination. Then when the autonomous vehicle 200 moves away from the additional destination, the cameras may stop recording images and may store the recorded images in the memory.

Accordingly, when the buyer gets into the autonomous vehicle 200 again after looking around the desired real estate for sale, the buyer may confirm images of surrounding destinations around which the buyer desires to look additionally through the display module 211 of the HMI 210.

As described above, the present disclosure acquires images of destinations additionally selected by a user through the autonomous vehicle 200 after the user alights. Accordingly, a client may look around facilities around real estate for sale without directly moving to the facilities.

Referring to FIG. 7, the server 100 may receive a purchase decision signal for desired real estate for sale through the HMI 210 (S110).

After confirming desired the real estate for sale, the buyer aboard the autonomous vehicle 200 may input a purchase decision signal through user manipulation to the interface displayed on the display module 211 of the HMI 210. The purchase decision signal may be a signal indicating that a buyer decided to buy desired real estate for sale.

The input module 213 may dataize a purchase decision signal and may transmit the dataized purchase decision signal to the server 100 through the second communication module 215, and the real-estate-for-sale managing module 120 provided in the server 100 may receive the purchase decision signal through the first communication module 150.

Next, the server 100 may acquire the location of a seller terminal 300 concerning the desired real estate for sale (S120).

Specifically, when the purchase decision signal is received, the path generating module 130 may acquire the current location of the seller terminal 300 from the GPS module provided in the seller terminal 300.

Then the path generating module 130 may generate a path for autonomous driving, which runs from the location of the desired real estate for sale to the acquired location of the seller terminal 300 (S130). A method for generating a path for autonomous driving is described above. Accordingly, detailed description is omitted.

When the buyer decided to buy the desired real estate for sale, the autonomous vehicle 200 may rightly move to the location of the seller, and when the autonomous vehicle 200 arrives at the location of the seller, the buyer and the seller may make a deal face to face.

As described above, when real estate for sale subject to purchase is determined, the present disclosure allows the autonomous vehicle 200 to move to the location of a seller, thereby causing no inconvenience of contacting sellers for real estate transactions, finding out the locations of the sellers, and directly moving to the locations of the sellers.

Below, an example of the process during which real estate services are provided as described above is described in a time series manner with reference to FIG. 8.

Referring to FIG. 8, a seller may register visit information, which include information on real estate for sale that the seller desires to sell, information on whether the real estate for sale is visitable, information on visitable time and the like, in the server 100 through a seller terminal 300 (S31), and the server 100 may store real-estate-for-sale information and visit information transmitted by the seller terminal 300 in a database 110 (S32).

Next, a buyer may get into an autonomous vehicle 200 and may input information on desired real estate that the buyer desires to buy through an HMI 210 in the autonomous vehicle 200 (S21), and the server 100 may extract real-estate-for-sale information, corresponding to desired-real-estate information transmitted by the HMI 210, from a database 110 (S12).

Next, the server 100 may transmit the extracted real-estate-for-sale information to the HMI 210 (S13), and the HMI 210 may output a real-estate-for-sale list on the basis of the real-estate-for-sale information received from the server 100 (S22).

The buyer may input information on desired real estate for sale that the buyer desires to buy, on the output real-estate-for-sale list, through the HMI 210 (S22), and the server 100 may generate a path for autonomous driving to one or more pieces of desired real estate for sale, which correspond to the desired-real-estate-for-sale information transmitted by the HMI 210 (S14). In generating a path for autonomous driving by the server 100, the location of desired real estate for sale, the question whether desired real estate for sale is visitable, visitable time and the like may be considered.

The server 100 may transmit the generated path for autonomous driving to the HMI 210 (S15), and the HMI 210 may control the autonomous vehicle 200 such that the autonomous vehicle 200 may move to the desired real estate for sale along the path for autonomous driving (S24). While the autonomous vehicle 200 is moving along the path for autonomous driving, the HMI 210 may generate GPS location information on the current location of the autonomous vehicle 200 through GPS signals of the autonomous vehicle 200 and may transmit the GPS location information to the server 100 (S25).

The server 100 may determine that the location of the autonomous vehicle 200 and the location of the desired real estate for sale are within a certain distance on the basis of the GPS location information, and may transmit authority to access the desired real estate for sale to the HMI 210 (S16).

The buyer or a real estate agent may confirm the access authority transmitted to the HMI 210 and may access the desired real estate for sale. Then when the buyer decided to buy the desired real estate for sale, the buyer may input a purchase decision signal through the HMI 210, and the input purchase decision signal may be transmitted to the server 100 (S6).

When receiving the purchase decision signal, the server 100 may transmit a purchase-decision-confirmation message to the seller terminal 300 (S17). The purchase-decision-confirmation message may be a message indicating that there is a buyer who decided to buy the real estate for sale.

Next, the server 100 may receive GPS location information on the current location of the seller terminal 300 from the seller terminal 300 (S32), and may generate a path for autonomous driving on the basis of the location of the seller terminal 300 (S18).

The server 100 may transmit the generated path for autonomous driving to the HMI 210 (S19), and the HMI 210 may control the autonomous vehicle 200 such that the autonomous vehicle 200 may move to the location of the seller along the path for autonomous driving (S27).

When the autonomous vehicle 200 arrives at the location of the seller, the buyer and the seller may make a deal face to face.

Additionally, the server 100 may receive a service termination signal and alighting location information through the HMI 210 while the above-described real estate services are being provided or after the above-described real estate services are provided.

Specifically, when the buyer and the seller of real estate made a deal face to face according to the process described in FIG. 8, or when the buyer and the seller failed to make a deal or when the buyer is not willing to make a deal, the buyer may input a service termination signal and alighting location information through an interface displayed on a display module 211of the HMI 210. An input module 213 of the HMI 210 may transmit the service termination signal and alighting location information to the server 100 through a second communication module 215, and the server 100 may receive the service termination signal and alighting location information through a first communication module 150.

The alighting location information may include information on a location from which the buyer desires to alight regardless of the above-described desired-real-estate information or real-estate-for-sale information.

Next, the server 100 may generate a path for autonomous driving, which runs from the current location of the autonomous vehicle 200 to a location corresponding to alighting location information. When the service termination signal is received, the autonomous vehicle 200 may be on the path, which runs from an initial position of the autonomous vehicle 200 to the location of the desired real estate for sale.

A path generating module 130 in the server 100 may identify the current location of the autonomous vehicle 200 through GPS signals received from a GPS module 214 of the autonomous vehicle 200. Additionally, the path generating module 130 may identify an alighting location corresponding to alighting location information by referring to the database 110 or by connecting to a traffic information server 500. On the basis of the alighting location, the path generating module 130 may generate a path for autonomous driving, which runs from the current location of the autonomous vehicle 200 to the alighting location.

A method for generating a path for autonomous driving is described above. Accordingly, detailed description is omitted.

Additionally, the server 100 may connect to any transportation server (not illustrated) and may call a transportation means, capable of moving to a location corresponding to alighting location information, to the location of the autonomous vehicle 200.

The transportation server may be a server that manages the run of any vehicle, and for example, may be a server of a taxi company, which manages the run of manned taxies or unmanned taxies (autonomous taxies).

The server 100 may identify the current location of the autonomous vehicle 200 through GPS signals received from the GPS module 214 of the autonomous vehicle 200. The server 100 may transmit the identified current location of the autonomous vehicle 200 as a departure location to the transportation server, and may transmit an alighting location corresponding to alighting location information as a destination to the transportation server to call a vehicle.

The transportation server may search for a transportation means capable of moving from the current location of the autonomous vehicle 200 to the alighting location and may allow the transportation means to move to the current location of the autonomous vehicle 200. For example, if a taxi managed by the transportation server is a manned taxi, the transportation server may provide information on the current location of the autonomous vehicle 200 to a driver of the taxi. If a taxi managed by the transportation server is an unmanned taxi, the transportation server may generate a path for autonomous driving from the current location of the taxi to the current location of the autonomous vehicle 200 and may control the taxi such that the taxi may run along the path for autonomous driving.

The above-described present disclosure may arrange real estate transactions through the autonomous vehicle 200, thereby enhancing efficiency and convenience of real estate transactions without causing clients to move.

The present disclosure may be replaced, modified and changed in different forms by one having ordinary skill in the art to which the disclosure pertains within the technical spirit of the disclosure. Thus, the present disclosure should not be construed as being limited to the embodiments and drawings set forth herein.

1. A method of providing real estate services using an autonomous vehicle, comprising:
receiving desired-real-estate information through a human machine interface (HMI) provided in an autonomous vehicle;
extracting a plurality of pieces of real-estate-for-sale information corresponding to the desired-real-estate information from a database, and transmitting the plurality of pieces of extracted real-estate-for-sale information to the HMI;
receiving desired-real-estate-for-sale information selected by a user among the plurality of pieces of real-estate-for-sale information through the HMI;
generating a path for autonomous driving to desired real estate for sale on the basis of the location of the desired real estate for sale and visit information on the desired real estate for sale included in the desired-real-estate-for-sale information; and
when the location of the autonomous vehicle and the location of the desired real estate for sale are within a certain distance on the path for autonomous driving, assigning authority to access the desired real estate for sale to the user.

2. The method of claim 1, wherein the autonomous vehicle is configured to travel along the path for autonomous driving.

3. The method of claim 1, wherein the step of receiving desired-real-estate information through a human machine interface (HMI) provided in the autonomous vehicle comprises receiving desired-real-estate information including at least one among pieces of information on an area in which desired real estate is located, a price of desired real estate, and the type of desired real estate through the HMI 210.

4. The method of claim 1, wherein the step of extracting a plurality of pieces of real-estate-for-sale information corresponding to the desired-real-estate information from a database comprises identifying a geo-fence on the basis of a location in which desired real estate included in the desired-real-estate information is placed, and extracting the plurality of pieces of real-estate-for-sale information within the identified geo-fence.

5. The method of claim 1, wherein the step of extracting a plurality of pieces of real-estate-for-sale information corresponding to the desired-real-estate information from a database, and transmitting the plurality of pieces of extracted real-estate-for-sale information to the HMI comprises generating a real-estate-for-sale list on which a plurality of pieces of real-estate-for-sale information are listed in the order of high similarity to the desired-real-estate information, and transmitting the generated real-estate-for-sale list to the HMI.

6. The method of claim 1, wherein the step of generating a path for autonomous driving to desired real estate for sale on the basis of the location of the desired real estate for sale and visit information on the desired real estate for sale included in the desired-real-estate-for-sale information comprises extracting visitable real estate for sale on the basis of visit information on a plurality of pieces of desired real estate for sale that are included in the desired-real-estate-for-sale information, and generating a path for autonomous driving to the visitable real estate for sale on the basis of the location of the extracted visitable real estate for sale.

7. The method of claim 1, wherein the step of generating a path for autonomous driving to desired real estate for sale on the basis of the location of the desired real estate for sale and visit information on the desired real estate for sale included in the desired-real-estate-for-sale information comprises calculating expected time of arrival for each of the plurality of pieces of desired real estate for sale included in the desired-real-estate-for-sale information;
extracting visitable real estate for sale, in which the expected time of arrival is later than visitable time included in the visit information, among a plurality of pieces of desired real estate for sale included in the desired-real-estate-for-sale information; and
generating a path for autonomous driving to the visitable real estate for sale on the basis of the location of the extracted visitable real estate for sale.

8. The method of claim 1, the method, further comprising:
receiving additional destination information through the HMI;
receiving a user alighting signal through the HMI;
generating a path for autonomous driving, which runs from the location of the autonomous vehicle to a location corresponding to the additional destination information back and forth; and
when the location of the autonomous vehicle and the location corresponding to the additional destination information are within a certain distance, transmitting a recording initiation signal for external images to a camera provided in the autonomous vehicle.

9. The method of claim 1, wherein the method further comprises transmitting surrounding facility information on the desired real estate for sale to the HMI while the autonomous vehicle is moving along the path for autonomous driving.

10. The method of claim 1, wherein the step of assigning authority to access the desired real estate for sale to the user when the location of the autonomous vehicle and the location of the desired real estate for sale are within a certain distance on the path for autonomous driving comprises transmitting an access password of the desired real estate for sale to at least one of the HMI and the user terminal.

11. The method of claim 1, wherein the step of assigning authority to access the desired real estate for sale to the user when the location of the autonomous vehicle and the location of the desired real estate for sale are within a certain distance on the path for autonomous driving comprises transmitting a virtual card key of the desired real estate for sale to the user terminal in which an access application is installed.

12. The method of claim 1, the method, further comprising:
receiving a purchase decision signal for the desired real estate for sale through the HMI;
acquiring a location of a seller terminal concerning the desired real estate for sale; and
generating a path for autonomous driving from the location of the desired real estate for sale to the location of the seller terminal.

13. The method of claim 1, the method, further comprising:
receiving a service termination signal and alighting location information through the HMI; and
generating a path for autonomous driving, which runs from the location of the autonomous vehicle to a location corresponding to the alighting location information.

14. The method of claim 1, the method, further comprising:
receiving a service termination signal and alighting location information through the HMI; and
connecting to a transportation server and calling a vehicle, capable of moving to a location corresponding to the alighting location information, to the location of the autonomous vehicle.
